(19) United States
(12) Patent Application Publication
(10) Pub. No.: US 2005/0151976 A1
(43) Pub. Date: Jul. 14, 2005

(54) Method for monitoring of analytes in biological samples using low coherence interferometry

(76) Inventor: Cristian E. Toma, Newtown, PA (US)

Correspondence Address: CANTOR COLBURN, LLP, 55 GRIFFIN ROAD SOUTH, BLOOMFIELD, CT, 06002, US

(21) Appl. No.: 11/014,480

(22) Filed: Dec. 16, 2004

Related U.S. Application Data
(60) Provisional application No. 60/530,018, filed on Dec. 16, 2003.

(51) Int. Cl. G01B 9/02

(52) U.S. Cl. 356/497

(57) ABSTRACT

A method for determining a characteristic of an analyte in a biological sample comprising: directing broadband light by means of a sensing light path at the biological sample; receiving the broadband light reflected from the biological sample; directing the broadband light by means of the reference light path at a reflecting device; and receiving the broadband light reflected from the reflecting device. The method also includes: interfering the broadband light reflected from the biological sample and the broadband light reflected from the reflecting device; detecting the broadband light resulting from the interfering to provide an interference signal indicative of a first intensity measurement corresponding to a first depth in the biological sample; and varying an effective light path length of at least one of the reference light path and the sensing light path to define a second depth in the biological sample. The method further includes: detecting the broadband light resulting from the interfering, to provide another interference signal indicative a second intensity measurement corresponding to the second depth; and determining the characteristic based on the intensity measurements.

### CROSS-REFERENCE TO RELATED APPLICATIONS

This application claims the benefit of U.S. provisional application No. 60/530,018, filed Dec. 16, 2003 the contents of which are incorporated by reference herein in their entirety.

### BACKGROUND

The invention relates to a method and system for determining the concentration of analytes in biological samples using low-coherence interferometry. The method is based on detecting and measuring changes in light scattering properties of biological samples induced by changes in the concentration of analytes present in the tissue. The term “biological sample” denotes a body fluid or tissue of an organism. Biological samples are generally optically heterogeneous, that is, they contain a plurality of scattering centers scattering irradiated light. In the case of biological tissue, especially skin tissue, the cell walls and other intra-tissue components form the scattering centers.

Generally, for the qualitative and quantitative analysis in such biological samples, reagents or systems of reagents is used that chemically react with the particular component(s) to be determined. The reaction results in a physically detectable change in the solution of reaction, for instance a change in its color, which can be measured as a measurement quantity. By calibrating with standard samples of known concentration, a correlation is determined between the values of the measurement quantity measured at different concentrations and the particular concentration. These procedures allow accurate and sensitive analyses, but on the other hand they require removing a liquid sample, especially a blood sample, from the body for the analysis (“invasive analysis”).

The American Diabetes Association (ADA) estimates that diabetes afflicts nearly 17 million people in the United States. Diabetes can lead to severe complications over time, including heart failure, kidney failure, blindness, and loss of limb due to poor peripheral circulation. According to ADA, complications arising from diabetes cost the U.S. health care system in excess of $132 Billion.

Diabetes complications are largely due to years of poor blood glucose control. The Diabetes Care and Complications Trial (DCCT) carried out by the National Institute of Diabetes and Digestive and Kidney Diseases (NIDDK) demonstrated that more frequent monitoring of blood glucose and insulin levels can prevent many of the long-term complications of diabetes.

Monitoring of blood glucose concentration is key to managing the therapy of diabetes patients. Monitoring results are used to adjust nutrition, medication, and exercise in order to achieve the best possible glucose control, reducing the complications and mortality associated with diabetes. At present, the most widely used method for monitoring of blood glucose by diabetes patients involves chemical analysis of blood samples taken by puncturing the finger or forearm. This method is painful, requires relatively complex operations, is inconvenient due to disruption of daily life, and may become difficult to perform in the long term due to calluses on the fingers and poor circulation. As a result, the average diabetic patient tests their blood glucose levels less than twice a day versus the recommended four or more times per day. Non-invasive blood glucose monitoring techniques with accuracies equal to or better than the current chemical glucose methods are therefore needed.

Non-invasive analyte monitoring approaches typically involve irradiating the biological sample of interest with non-ionizing radiation such as light (hereinafter the term “light” includes also the ultraviolet and infrared spectral ranges, in addition to the visible spectral range), or radio-frequency electromagnetic fields. The radiation emerging from the biological sample (through transmission or backscattering) is detected in order to measure a set of physical properties of the radiation that correlate with the concentration of analytes present in the biological sample, named hereafter “observables”. The accuracy of non-invasive methods depends on the sensitivity and specificity of the observables with respect to the analyte of interest.

Accordingly, a number of procedures and apparatus have been suggested to determine glucose in blood, tissue and other biological samples in vivo and in a non-invasive manner. Existing non-invasive procedures for glucose determination include nuclear magnetic resonance (NMR), electron spin resonance (ESR) and infrared spectroscopy. However, none of these procedures have achieved practical significance. Large and costly equipment is required, which are wholly unsuitable for routine analysis or even for patient self-checking (home monitoring).

One of the most promising approaches for non-invasive glucose monitoring is based on optical techniques. Optical glucose monitoring techniques are particularly attractive in that they are relatively fast, use non-ionizing radiation, and generally do not require consumable reagents. Several optical glucose-monitoring techniques have been proposed so far, with varying degrees of success. Several of these techniques are discussed herein as background, however, once again, none of these techniques has attained significant commercial success relative to invasive techniques.

One approach is Near-Infrared (NIR)/Mid-Infrared (MIR) spectroscopy. In infrared spectroscopy, radiation from external light sources is transmitted through or reflected by a body part. Spectroscopic techniques are used to analyze the amount of radiation absorbed at each wavelength by the body part constituents and to compare the absorption data to known data for glucose. Practical implementation of a glucose sensor based on these principles is very difficult and several wavelengths are required. Infrared (IR) spectra are sensitive to physical and chemical factors such as temperature, pH, and scattering. Furthermore, spectroscopy is affected by skin pigmentation, use of medications that absorb various IR wavelengths, alterations in blood levels of hemoglobin or other proteins that absorb IR, changes in body temperature, and alterations in the state of hydration or nutrition. In addition, the NIR spectrum of glucose is very similar to that of other sugars, including fructose, which is often used by diabetics. Therefore, the signal (i.e. the change in the absorption spectrum as a function of glucose concentration) is very small compared to noise and to interference resulting especially from the water spectral absorption and other strongly absorbing components.

Another approach is Raman Spectroscopy. With Raman spectroscopy, Raman spectra are observed when incident radiation is inelastically scattered. The loss or gain of photon energy are independent of the excitation frequency and provide specific information about the chemical structure of the sample. The Raman signal is very weak, requiring long data acquisition time, making the device sensitive to light source fluctuations. Measurements are subject to high background noise because of tissue autofluorescence. Scatter and reabsorption in biological tissues make detection of Raman frequency shifts due to physiological concentrations difficult.

Another spectroscopic approach is based on photoacoustics. In photoacoustic spectroscopy, a laser beam pulse is used to rapidly heat the tissue and generate an acoustic pressure wave that can be measured by a microphone or other transducer. The acoustic signal is analyzed to infer blood glucose concentration. Measurements are affected by chemical interferences from biological molecules as well as physical interference from temperature and pressure changes. Current instruments are complex and sensitive to environmental conditions.

Another optical approach considered of glucose monitoring is based on employing polarimetry. Glucose concentration changes the polarization of light fields. The eye's aqueous humor has been suggested as the medium for this technique as skin is not a feasible site due to its high light scattering properties. However, polarization measurements are affected by optical rotation due to cornea, and by other optically active substances. Other interfering factors include saccadic motion and corneal birefringence. In addition, there is a significant lag between blood glucose changes and glucose changes in intra-ocular fluids, of up to 30 minutes.

Yet, another approach employed for glucose monitoring is based on light scattering. Changes in glucose levels induce changes in light scattering properties, generally, of the skin. U.S. Pat. No. 6,226,089 to Hakamata discloses detecting the intensities of backscattering light generated by predetermined interfaces of an eyeball when a laser beam emitted from a semiconductor laser is projected onto the eyeball in a predetermined position. The absorbance or refractive index of the aqueous humor in the anterior chamber of the eyeball is determined on the basis of the intensities of the backscattering light, and the glucose concentration in the aqueous humor is determined on the basis of the absorbance or refractive index in the aqueous humor. Light scattering effects are evident in the near-infrared range, where water absorption is much weaker than at larger wavelengths (medium- and far-infrared). However, techniques that rely on the backscattered light from the aqueous humor of the eye are affected by optical rotation due to cornea, and by other optically active substances. Other interfering factors include saccadic motion and corneal birefringence. Finally, it should be appreciated that there is often a significant time lag, (e.g., up to 30 minutes) between blood glucose changes and glucose changes of the intra-ocular fluids.

Low-Coherence Interferometry (LCI) is one technique for analyzing skin light scattering properties. Low Coherence Interferometry is an optical technique that allows for accurate, analysis of the scattering properties of heterogeneous optical media such as biological tissue. In LCI, light from a broad bandwidth light source is first split into sample and reference light beams which are both retro-reflected, from a targeted region of the sample and from a reference mirror, respectively, and are subsequently recombined to generate an interference signal. Constructive interference between the sample and reference beams occurs only if the optical path difference between them is less than the coherence length of the source.

U.S. Pat. No. 5,710,630 to Essenpreis et al. describes a glucose measuring apparatus for the analytical determination of the glucose concentration in a biological sample and comprising a light source to generate the measuring light, light irradiation means comprising a light aperture by means of which the measuring light is irradiated into the biological sample through a boundary surface thereof, a primary-side measuring light path from the light source to the boundary surface, light receiving means for the measuring light emerging from a sample boundary surface following interaction with said sample, and a secondary-side sample light path linking the boundary surface where the measuring light emerges from the sample with a photodetector. The apparatus being characterized in that the light source and the photodetector are connected by a reference light path of defined optical length and in that an optic coupler is inserted into the secondary-side measurement light path which combines the secondary-side measuring light path with the reference light path in such manner that they impinge on the photodetector at the same location thereby generating an interference signal. A glucose concentration is determined utilizing the optical path length of the secondary-side measuring light path inside the sample derived from the interference signal.

Unfortunately, the methods discussed herein do not generally allow absolute measurements of the analyte concentration, and therefore calibration is required. For invasive, analytical approaches, the calibration step is typically performed using calibration/control solutions with known concentration of analytes in order to correlate the values of the observables with absolute values of analyte concentration. Calibration procedures for non-invasive monitoring approaches are more difficult to implement in practice. The interaction between radiation and biological samples is a complex phenomenon, mainly due to the high complexity of biological sample microstructure and composition. Because of this complexity, variations in the observables depend on variations of many factors in addition to the concentration of the analyte of interest. Isolating those changes that are due to the analyte of interest alone, and using them to predict analyte concentration is a significant challenge in itself that should be addressed by the calibration procedure. An added challenge is due to the fact that the biological sample, microstructure, and composition differ from one individual to another; therefore, non-invasive analyte instruments should also be calibrated for a specific individual. As an additional practical consideration, the calibration process should preferably be quick to perform and required infrequently. Acceptable calibration methods should also have the capability to operate with limited amounts of calibration samples.

### BRIEF SUMMARY

Disclosed herein in an exemplary embodiment is a method for determining a characteristic of an analyte in a biological sample. The method comprising: directing broadband light by means of a sensing light path at the biological sample; receiving the broadband light reflected from the biological sample by means of the sensing light path; directing the broadband light by means of the reference light path at a reflecting device; and receiving the broadband light reflected from the reflecting device by means of the reference light path. The method also includes: interfering the broadband light reflected from the biological sample and the broadband light reflected from the reflecting device; detecting the broadband light resulting from the interfering of the broadband light reflected from the biological sample and the broadband light reflected from the fixed reflecting device, to provide an interference signal indicative of a first intensity measurement of the broadband light resulting from the interfering corresponding to a first depth in the biological sample; and varying an effective light path length of at least one of the reference light path and the sensing light path to define a second depth in the biological sample. The method further includes: detecting the broadband light resulting from the interfering of the broadband light reflected from the biological sample and the broadband light reflected from the fixed reflecting device, to provide another interference signal indicative a second intensity measurement of the broadband light resulting from the interfering corresponding to the second depth in the biological sample; and determining the characteristic of the analyte in the biological sample based on the intensity measurements corresponding to the first depth in the biological sample and the second depth in the biological sample.

Also disclosed herein in an exemplary embodiment is a system for determining a characteristic of an analyte in a biological sample, the system comprising: a broadband light source for providing a broadband light; a sensing light path receptive to the broadband light from the broadband light source, the sensing light path configured to direct the broadband light at the biological sample and to receive the broadband light reflected from the biological sample; and a reflecting device. The system also includes a reference light path receptive to the broadband light from the broadband light source, the reference light path configured to direct the broadband light at the reflecting device and to receive the broadband light reflected from the reflecting device, the reference light path coupled with the sensing light path to facilitate interference of the broadband light reflected from the biological sample and the broadband light reflected from the fixed reflecting device; and a detector receptive to the broadband light resulting from an interference of the broadband light reflected from the biological sample and the broadband light reflected from the reflecting device, the detector configured to generate an interference signal indicative of the broadband light resulting from the interference. The system further includes: means for varying an effective light path lengths of at least one of the reference light path and the sensing light path; and a processor configured to; (1) determine a first intensity measurement based on the interference signal for a first depth, the first depth defined by the effective light path lengths of the sensing light path and a reference light path, (2) determine a second intensity measurement based on the interference signal for a second depth, the second depth defined by effective light path lengths of the sensing light path and a reference light path, and (3) determine the characteristic of the biological sample from the first intensity measurement and the second intensity measurement.

Also disclosed herein in yet another exemplary embodiment is a system for determining a characteristic of an analyte in a biological sample, the system comprising: means for directing broadband light by means of a sensing light path at the biological sample; means for receiving the broadband light reflected from the biological sample by means of the sensing light path; means for directing the broadband light by means of the reference light path at a reflecting device; means for receiving the broadband light reflected from the reflecting device by means of the reference light path; and means for interfering the broadband light reflected from the biological sample and the broadband light reflected from the reflecting device. The system also includes: means for detecting the broadband light resulting from the interfering of the broadband light reflected from the biological sample and the broadband light reflected from the reflecting device, to provide an interference signal indicative of a first intensity measurement of the broadband light resulting from the interfering corresponding to a first depth in the biological sample; and means for varying an effective light path length of at least one of the reference light path and the sensing light path to define a second depth in the biological sample. The system also includes: means for detecting the broadband light resulting from the interfering of the broadband light reflected from the biological sample and the broadband light reflected from the fixed reflecting device, to provide another interference signal indicative a second intensity measurement of the broadband light resulting from the interfering corresponding to the second depth in the biological sample; and means for determining the characteristic of the analyte in the biological sample based on the intensity measurements corresponding to the first depth in the biological sample and the second depth in the biological sample.

Further disclosed herein in yet another exemplary embodiment is a storage medium encoded with a machine-readable computer program code for determining a characteristic of an analyte in a biological sample including instructions for causing a computer to implement the above-mentioned method.

Further yet, disclosed herein in an exemplary embodiment is a computer data signal embodied in a computer readable format for determining a characteristic of an analyte in a biological sample, the computer data signal including instructions for causing a computer to implement the above mentioned method.

### BRIEF DESCRIPTION OF DRAWINGS

These and other features and advantages of the present invention may be best understood by reading the accompanying detailed description of the exemplary embodiments while referring to the accompanying figures wherein like elements are numbered alike in the several figures in which:

FIG. 1 is a schematic and block diagram of a basic low-coherence interferometry system in a set-up specific to non-invasive measurement of analytes in biological tissue;

FIG. 2 is a typical optical path-length distribution obtained with a low-coherence interferometer and illustration of depth penetration of the photons into the tissue; and

FIG. 3 is a schematic of the non-invasive analyte concentration measuring system configured for calibration.

### DESCRIPTION OF AN EXEMPLARY EMBODIMENT

Described herein in one or more exemplary embodiments is a system and method for non-invasive analyte concentration measurement in biological tissue, using a Low-Coherence Interferometry (LCI). More particularly, a method for analyte concentration monitoring in biological samples by analyzing light scattering properties of that biological sample using Low-Coherence Interferometry and multiple-scattering models of the interaction between light and the biological sample. The disclosed methodology includes the following advantages: a) multiple-scattering models describe additional light scattering phenomena in optically dense biological samples, b) multiple-scattered light waves travel along longer paths through the biological samples and therefore generally accumulate more information about the presence of analytes, and c) multiple scattering inherently performs a spatial averaging of local tissue inhomogeneities. Another exemplary embodiment provides a calibration procedure suitable for analyte concentration monitoring in biological samples. The calibration procedure is cast as a statistical regression problem that is solved in the framework of the statistical learning theory. One advantage is the availability of certain statistical learning approaches that have been proven to provide superior solutions to regression problems when only limited amounts of calibration samples are available, which is a situation generally encountered in most practical situations.

The method presented herein is based on an approach different from all of the above, and is based on the analysis of the changes in light scattering properties of biological samples, induced by changes in the concentration of the analyte of interest in that sample. Monitoring analyte concentration by scattering properties rather than by the absorption properties has several advantages. First, biological sample scattering effects are evident in the NIR range of the electromagnetic spectrum, where absorption from water molecules is lower, and therefore light penetration into biological samples is good. Second, high performance optical devices in the NIR range are readily available, due to their high demand in the telecommunications industry.

It is well known that biological samples (biological tissue and/or body fluids) are generally optically heterogeneous. Biological samples typically consist of cells and extra-cellular fluids. In the case of biological tissue, the cell membranes, intra-cellular components and protein aggregates are the main scattering centers. The same is true also for most body fluids, for example, blood, which contains various types of blood cells and protein aggregates. The refractive index mismatch between the cell membranes (acting as scattering centers) and the surrounding extra-cellular fluid varies when the analyte of interest is present in the extra-cellular fluid, with varying concentrations. Refractive index mismatch variations, result in variations of the scattered light field properties—the observables.

Electromagnetic wave propagation in heterogeneous media can be characterized in terms of the absorption coefficient μₐ, the scattering coefficient μₛ, and the anisotropy factor g. It is well known from the theory of electromagnetic wave scattering that for a given wavelength of the incident electromagnetic radiation, the scattering coefficient μₛ of an optically heterogeneous medium depends on: a) the mismatch between the refractive index of the scattering centers and the refractive index of the surrounding medium, b) the volume density of scatterers, and c) the size and geometry of individual scatterers. Any of these three factors can be used as a mechanism for generating measurable changes in the scattering properties of the biological sample, provided the analyte of interest effects changes in that factor. However, in the case of practical analyte concentration monitoring in biological samples, the mismatch between the refractive index of the scattering centers and the refractive index of the surrounding medium is the principal factor that generates measurable changes in the scattering properties of the biological sample as explained in the following.

An illustrative (but not limiting) example is that of non-invasive glucose monitoring in the skin. The dermis layer of the skin lies at depths between 200 microns and 1-2 millimeters (mm) under the skin surface, and consists largely of collagen fibers that range between 2-15 μm in diameter and embedded in a medium made of water and glycoproteins—the Interstitial Fluid (ISF). In the NIR range the refractive index of ISF is 1.348-1.352, whereas the refractive index of cellular membranes and protein aggregates ranges from 1.350 to 1.460. This refractive index mismatch is the source of a significant proportion of scattering of light from dermis. The dermis is a highly vascular tissue. Due to its osmotic properties, glucose passes from blood into the dermis ISF. The physiological delay of blood glucose transfer from blood to the ISF is of the order of only 2-5 minutes, therefore blood glucose variations can be tracked in the dermis ISF with an acceptable lag. Raising the glucose concentration in the ISF raises the ISF refractive index by approximately 1.52×10⁻⁵ per each mg/dl of glucose concentration and thus decreases the refractive index mismatch, leading to a decrease of the dermis scattering coefficient μₛ value. Therefore, μₛ may be inferred from measurable properties of the scattered light field (the observables), as it will be explained at a later point herein.

Finally, it will also be appreciated that while the exemplary embodiments disclosed herein are described with reference and illustration to detection and evaluation of analytes such as glucose and glucose concentration, applications and implementations for determination of other biological constituents or analytes may be understood as being within the scope and breadth of the claims. For example, the embodiments disclosed herein may readily be adapted for invasive or non-invasive applications including, but not limited to detection and evaluation of other analytes as well as detection and evaluation of other microstructures including, but not limited to atheroma and plaques.

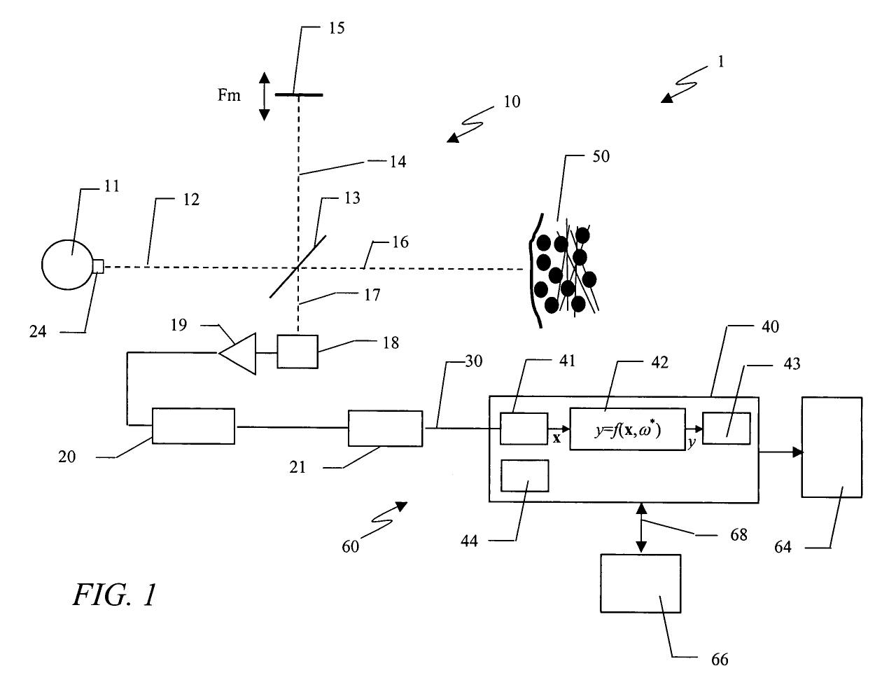

The analyte monitoring approach disclosed herein requires an appropriate method for analyzing scattering properties of biological samples. Low coherence interferometry (LCI) is an optical technique that allows for accurate, depth-resolved analysis of scattering properties of heterogeneous optical media such as biological tissue. FIG. 1 illustrates (without limiting) a basic low-coherence interferometry system 1 in a set-up specific to non-invasive measuring of analytes in biological tissue, consisting in a low-coherence interferometer 10 connected to a computer 40 using a standard communication interface 30. The low coherence interferometer 10 injects low coherence light into the biological sample 50 via a sample arm 16 that can be built using optical fiber, waveguides, bulk optics and the like, as well as combinations including at least one of the foregoing. It should also be noted that the light wavelengths discussed below for such methods may be in the range of about 300 to about several thousand nanometers (nm), that is, in the spectral range from near ultraviolet to near infrared light. In an exemplary embodiment, for the sake of illustration, a wavelength of about 1300 nm is employed. The term “light” as used herein is not to be construed as being limited or restricted to the visible spectral range. However, it should be appreciated that LCI can occur in any interferometric system using broad frequency or wavelength bandwidth.

Continuing with FIG. 1, referring to the low coherence interferometer system 10, a low coherence light source 11, for example, a super luminescent diode (SLD) with an isolator 24 configured to ensure that feedback to the SLD is maintained at less than a selected threshold, couples the light through an optical fiber 12 to a beam splitter 13, for example a 2×2 beam splitter. The 2×2 beam splitter 13 divides the light field coupled from the optical fiber 12 into a light field coupled to a reference arm 14 that can be implemented using optical fiber, waveguides, and the like, and a light field coupled into the sample arm 16, that can also be implemented using optical fiber, waveguides, and the like. The reference arm 14 is terminated with a reference reflecting device 15 e.g., mirror and the like, that can be displaced in a controlled manner along the optical axis of the reference arm 14 such that the optical path-length of the reference arm 14 can be varied. Furthermore, the optical path length of the reference arm 14 may be manipulated employing other non-moving means, for example, a waveguide modulator or a piezoelectric transducer with the reference arm fiber 12 wound thereon. The optical path-length is the distance traveled by light fields taking into account the group velocity of the propagation medium. In a homogeneous medium, the optical path-length lₒ is the product of the refractive index of the medium n and the geometric path-length l_{g} as in lₒ=n l_{g}.

Continuing with FIG. 1, in an exemplary embodiment, the light fields traveling along the reference arm 14 and the sample arm 16 are both retro-reflected, from the reference mirror 15 and the biological sample 50, respectively, and are subsequently recombined at the surface of the detector 18. The electrical current generated by the detector 18 is sent to a processing system, shown generally as 60 that may include, but not be limited various elements to facilitate processing the signal provided by the detector 18. In an exemplary embodiment, the detector current is amplified by a pre-amplifier 19. The amplified electrical current carries an interference signal, which is detected by an interference signal detector 20. The detected signal is converted to digital representation by an analog/digital converter 21 and sent to a computer 40 via a standard communication interface 30.

In order to perform the prescribed functions and desired processing, as well as the computations therefore (e.g., the computations associated with detecting and utilizing the interference signal, and the like), the LCI system 10, and more particularly, the processing system 60, may include, but is not limited to a computer system including central processing unit (CPU) 40, display 64, storage 66 and the like. The computer system may include, but not be limited to, a processor(s), computer(s), controller(s), memory, storage, register(s), timing, interrupt(s), communication interface(s), and input/output signal interfaces, and the like, as well as combinations comprising at least one of the foregoing. For example, computer system may include signal input/output for controlling and receiving signals from the interference signal detector 20 or converter 21 as described herein. Additional features of a computer system and certain processes executed therein may be disclosed at various points herein.

The processing performed throughout the LCI system 1, may be distributed in a variety of manners. For example, distributing the processing performed in one ore more modules and among other processors employed. In addition, processes and data may be transmitted via a communications interface 30, media 66, and the like to other processors for remote processing, additional processing, storage, and database generation. Such distribution may eliminate the need for any such component or process as described or vice versa, combining distributed processes in a various computer systems. Each of the elements described herein may have additional functionality that will be described in more detail herein as well as include functionality and processing ancillary to the disclosed embodiments. As used herein, signal connections may physically take any form capable of transferring a signal, including, but not limited to, electrical, optical, or radio.

The computer 40 executes several programs (or routines), as it follows. Signal pre-processing and feature extraction routine denoted as 41 takes the digitized interferometric signal as input, scales and filters it, and a generates a vector x=(xₗ, . . . x_{d}) of observables (or features) using a dimensionality reduction technique described later in the present invention disclosure. Each element of the vector x is a scalar that represents the value of an observable (or feature) measured on the digitized, scaled and filtered interferometric signal. Predictor program denoted as 42 that takes as input the observables vector x and generates an output y that represents an estimate of the analyte concentration in the biological tissue 50 generates the output according to a prediction function y=f(x, ω*), where ω* is a parameter from a parameter set Ω. The function f and the parameter ωₒ are determined during the calibration process using a statistical regression procedure, which is outlined later in this document. User interface 43 includes display 64 that displays the output value y. Reference numeral 44 denotes a command and control program that coordinates the operation of the interferometer system 1, of the programs and routines 41 and 42 and of the user interface 43 and the like.

Constructive interference between the retro-reflected sample arm 16 light field and reference arm 14 light field occurs only if the optical path difference between them is less than the coherence length of the light source 11. By sweeping the reference mirror 15, and thus varying the optical path-length of the reference arm 14 and synchronously recording the interference signal the optical signatures corresponding to selectable depths in the sample may be attained and measured.

In interferometric systems, frequency modulation may be employed to isolate the portion of the interferometric signal caused by interference. This modulation may be implemented by modulating the optical path-length of at least one of the interferometer arms 14, 16, for example, that of the reference arm 14. In an exemplary embodiment, the modulation may be accomplished by oscillating the reference mirror 15 along the optical axis of the reference arm 14, or by using another device to manipulate the optical length of either the reference arm 14, for example, waveguide modulator or piezoelectric transducer with the reference arm fiber 12 wound thereon. The oscillation amplitude is typically less than one wavelength of the light emitted by the light source 11, and the modulation frequency fₘ is of the order of a few tens of kilohertz. In this manner, the AC component of the electrical current generated by the detector 18 that carries the interference signal is shifted in the frequency domain by the modulation frequency fₘ. This modulated AC component is selectively amplified and measured using conventional heterodyning techniques, allowing for highly sensitive measurements. Dynamic ranges in excess of 80-90 dB may readily be obtained with state-of-the-art LCI technology and heterodyning. Moreover, the depth resolution of low-coherence interferometers such as that depicted in FIG. 1, equals the coherence length of the light source 11. Thus, depth resolutions of the order of 10-15 microns are easily achieved when employing state-of-the art low coherence light sources 11.

Several methods for analyte monitoring in biological samples using LCI-based systems have been disclosed, more specifically for glucose monitoring in skin tissue and/or the intra-ocular fluid. One of the methods disclosed in U.S. Pat. No. 5,710,630 measures the refractive index of a fluid by measuring the optical path length of a beam of light passing through that fluid. The method requires an optically quasi-homogeneous medium, condition that is met only for the intra-ocular fluid. For biological samples other than the intra-ocular fluid, these methods generally assume a single-scattering light-tissue interaction regime, that is, photons encounter only one scattering event before exiting the biological sample and being detected. In the single-scattering approximation, the Beer-Lambert law is used to model the attenuation of the light flux through the biological sample as I(z)=I₀ exp(−μₜz), where z is the depth, and μₜ=μₐ+μₛ is the total attenuation coefficient, μₐ is the absorption coefficient, and μₛ is the scattering coefficient. Using a light source operating in NIR (e.g. at a central wavelength of 1,300 nm), μₐ is negligible, and μₜ≈μₛ. Based on the single-scattering model, changes in the slope of the LCI signal intensity vs. depth are recorded in order to monitor scattering coefficient changes, which are related to variations in ISF glucose levels. However, In many instances, biological samples are dense, layered, and highly anisotropic optical media. In such a medium, the single scattering approximation may be limited. For analyte monitoring conducted at deeper layers of the biological sample, models that must accurately describe light-sample interactions at deeper layers of the biological sample are needed.

In order to ensure accurate operation of an LCI system 10 such as the one shown in FIG. 1, for detecting analytes, two matters are to be addressed: first, a definition of the observables (or features) vector x, and second, specification of the prediction function y=f(x, ω*), where ω* is a parameter from a parameter set Ω. In the absence of an analytical form for the optimal prediction function f(x, ωₒ), where ωₒ ε Ω, and exemplary embodiment describes a statistical regression procedure for finding an estimate (approximation) of the optimal prediction function, denoted by f(x, ω*), given a limited set of calibration samples (xⁱ, yⁱ), with i=1, . . . , n.

The vector of observables (or features) x is defined within the framework of multiple scattering modeling of light-tissue interactions. Multi-scattering regimes associated with wave propagation through optically dense random media such as tissue are usually described in terms of diffusion equations. This is an approximation for energy transport that assumes isotropic elastic scattering and wave propagation at constant group velocity, while neglecting polarization and interference effects.

Diffusive wave propagation is characterized by the probability density P(s) of optical path lengths through the medium. The time t necessary for the optical wave to propagate along a path of length s is given by t=s/v, where v is the average velocity of energy transport. Considering a constant energy transport velocity v, then v=3D/lₜ, where D is the diffusion coefficient of the medium and lₜ is the steady state transport mean-free path. In steady-state conditions, lₜ depends on the scattering coefficient μₛ and the average cosine of the scattering angle g, as in lₜ=[μₛ (1−g)]⁻¹. This definition is valid for lₜ>>λ (the radiation's wavelength).

If the light waves travel within the tissue over distances much larger than lₜ, and if the absorption is negligible compared to scattering (as it is the case for dermis in NIR, for example, absorption is on the order of 100 times less than scattering in tissue for NIR), the diffusion equation takes the form:

$$( \frac{\partial }{\partial t} - D {∇}^{2} ) Φ ( r , t ) = S ( r , t ) \qquad ( 1 )$$

where Φ is the diffuse energy density, D is the diffusion coefficient of the medium, and S is the source term, considered to be isotropic. Using the appropriate boundary conditions, the diffusion equation (1) can be solved for particular geometries to calculate the energy density Φ. Then the energy flux j can be obtained using Fick's law:
j(r,t)=−D∇Φ(r,t) (2)

For media of finite thickness, the condition under which the diffusion theory is generally valid is lₜ/L<<1, where L is the thickness of the random medium. Unfortunately, the diffusion approximation becomes less and less reliable when the thickness of the sample decreases and the anisotropy factor g increases. However, when internal reflections at the boundary and scattering anisotropy are properly taken into account in the boundary conditions, diffusion predictions are accurate for samples as thin as about 5 lₜ. For example, for NIR, lₜ for human dermis is less than 100 μm. Therefore, with the appropriate boundary conditions, the diffusion approach can be expected to hold for human dermis layers thicker than 500 μm, a condition that can be readily met in practice.

Of particular interest for the invention described herein are boundary conditions specific to semi-infinite media. It is noteworthy to appreciate that the refractive index mismatch between air and tissue causes the photons that “try” to exit the biological sample to be resent back into the tissue because of the total internal reflection process. The overall effect is a reduction of the effective diffusion coefficient of the tissue. Therefore, identification of appropriate boundary conditions is needed in order to extend the applicability of the diffusion model closer to the interface. One approach, which is also the most general, is to use a mixed boundary condition, which for a semi-infinite medium can be written as:

$${[ Φ - {z}_{e} {l}_{t} \frac{\partial Φ}{\partial z} ]}_{z = 0} = 0 \qquad ( 3 )$$

where zₑ is called the extrapolated length ratio, since zₑlₜ is the distance outside the tissue where Φ extrapolates to zero. Using a partial current technique, zₑ depends on the reflection phenomenon at the boundary and is given by:

$${z}_{e} = \frac{2}{3} \frac{1 + {R}_{eff}}{1 - {R}_{eff}} \qquad ( 4 )$$

where R_{eff} is the effective reflectivity at the interface.

Furthermore, a Low-Coherence Interferometer such as that depicted in FIG. 1 can be used to investigate the multi-scattering regime of wave propagation. This technique, called optical path-length spectroscopy (OPS), directly infers the path-length distribution of waves scattered by a random medium.

With reference to the LCI geometry shown in FIG. 1, assuming quasi-monochromatic fields, the intensity sensed by the detector is:
I_{d}=Iₛ+I_{ref}+2\sqrt{IₛI_{ref}}|Γ(Δs)|cos(2πΔs/λ+φ) (5)
where I_{d}, Iₛ, I_{ref} are the detected, scattered (sample), and reference intensities, respectively and φ is the phase associated with the complex degree of coherence Γ(Δs). The optical path difference between the scattered and the reference fields is denoted as Δs, and λ is the central wavelength of the source. An interference maxima, is obtained when Δs is a multiple of the wavelength, and b) |Δs|<l_{coh} where l_{coh} is the coherence length of the source. Advantageously, because of the second condition, the LCI system 10 acts as a band-pass filter in the optical path-length domain, with a bandwidth given by the coherence length of the source.

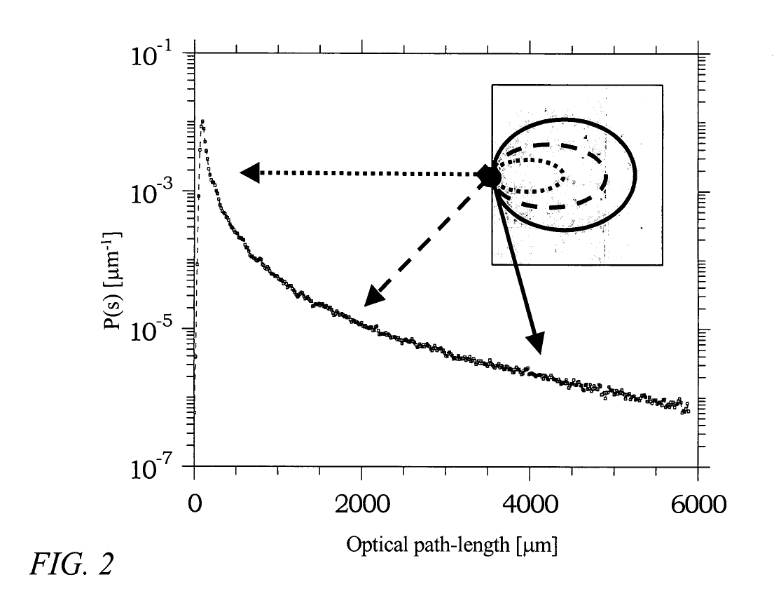

Typical LCI systems are equipped with sources hiving coherence lengths of 15-20 μm at λ=1300 nm. This bandpass filter phenomenon is centered on the length of the reference arm 14. If the reference mirror 15 sweeps the reference arm 14, waves with different optical path-lengths through the tissue are detected, and an optical path-length distribution is detected. Such a distribution obtained with an LCI system is shown in FIG. 2. As may readily be observed in FIG. 2, the OPS approach may be experimentally limited by the fact that signals corresponding to long paths within the tissue are weaker and a large dynamic range is needed for accurate measurements in the tails of path-length distributions. Advantageously, because of heterodyning techniques, dynamic ranges of 80-90 dB are routinely obtained with state-of-the art LCI technology.

The diffusion equation (1) can be solved together with the boundary condition (3) using the image source method for the particular geometry of the LCI system shown in FIG. 1 (r=0, photons are injected and collected at the same location via an optical fiber probe). Furthermore, using Fick's law (see equation (2)), the energy flux in the particular LCI geometry and for negligible absorption can be evaluated as:

$$J ( s ) = {Al}_{t}^{- 3 / 2} {z}_{e} {s}^{- 5 / 2} exp ( - \frac{3 {z}_{e}^{2} {l}_{t}}{4 s} ) \qquad ( 6 )$$

where s is the optical path-length, A is a constant, lₜ=[μₛ (1−g)]⁻¹ is the steady state transport mean-free path, and zₑ is the extrapolated length ratio—see eq. (4). Note the s^{-5/2} behavior of energy flux for diffusive waves with large optical path-lengths. The path-resolved backscattered intensity curves detected with the LCI system can be normalized with the area under the curve ∫J(s)ds in order to obtain probability densities of optical path-length distributions P(s) such as the one shown in FIG. 2. Due to its ability to measure optical path-length distributions P(s), OPS is useful for investigating the multi-scattering regime of light propagation through tissue.

In an exemplary embodiment a vector of primary observables x^{(p)} is constructed using the statistical moments of optical path-length distributions and/or scaled steady state transport mean-free path length as observables. As discussed above, the optical path-length distribution P(s) can be directly obtained from LCI measurements via a normalizing operation. Statistical moments of P(s) can be calculated and used to monitor variations in analyte concentration. Since the presence of analytes changes the scattering intensity of the tissue, P(s) is skewed towards larger or lower values of s as the analyte concentration changes. After normalizing the LCI signal with the area under the curve such that P(s)=J(s)/∫J(s)ds the first m statistical moments of the optical path length of photons through the scattering medium are calculated with the following formula:
E[sⁿ]=∫sⁿP(s)ds with n=1, . . . , m (7)

Similarly, to address scaled steady state transport mean-free path red as an observable, the reduced scattering coefficient μₛ^{red}=μₛ (1−g) is related to the steady state transport mean-free path lₜ by lₜ=[μₛ^{red}]⁻¹. The scaled steady state transport mean-free path zₑ²lₜ is inferred by fitting LCI signals acquired with an apparatus such as the one in FIG. 1 to equation (6). Since the presence of the analyte induces changes in the reduced scattering coefficient, the value of zₑ²lₜ changes as the analyte concentration changes.

The calculation of the primary observables can be performed directly on the acquired LCI signal, or preferably, on a filtered version of the acquired LCI signal with improved signal to noise ratio. With reference to FIG. 1, the filtering procedure is executed by the signal pre-processing and feature extraction routine 41.

In this way, a vector of primary observables x^{(p)} is obtained having a dimension of m+1 is obtained, where m is the number of statistical moments retained in Equation (7). It is usually recommended to keep the dimensionality of the observables vector as low as possible. For this purpose, a Principal Component Analysis (PCA) may be performed in the m+1 dimensional space of primary observable vectors x^{(p)} in order to verify how many of the m+1 dimensions carry information. PCA identifies a linear transformation of the original (m+1)-dimensional data such that in the transformed space the (m+1) dimensions are uncorrelated (their covariance matrix is the unitary matrix in the transformed space). The linear transformation is defined by a (m+1)x(m+1) matrix whose columns are the Principal Vectors. Each Principal Vector is associated with a real number, named Principal Value. For any dimension in the transformed space, its Principal Value is a measure of the information carried by that dimension. Higher Principal Values correspond to more information. In the transformed space, one can retain then only a few dimensions, corresponding to the highest values of the Principal Values. The resulting observables vector x=(xₗ, . . . , x_{d}) has a lower dimension than the primary observables vector x^{(p)} i.e., d<m+1. With reference to FIG. 1 once again, the observables vector x=(xₗ, . . . , x_{d}) is calculated by the signal pre-processing and feature extraction routine 41. One final step in the calculation of the observables vector x is scale normalization. Scale normalization is ensures that various observables from the feature vector x having different natural scales, do not introduce an artificial bias. Rescaling of the observables to a common range could be performed independently for each variable, for example, by scaling each observable by the standard deviation of its values. For the remainder of this description scale normalized observables are assumed and denoted by the vector x.

Calibration—Determination of the Prediction Function

The determination of a prediction function may be cast as a predictive learning problem. Predictive learning is the process of estimating an unknown dependency between the input x and output y variables using a limited set of past observations of (x, y) values (calibration or training samples). The output y is a random variable, which in the particular case of non-invasive analyte concentration measuring takes on real values. The unknown x-y dependency is therefore a real-valued function of real-valued multidimensional argument x.

The problem is therefore that of estimating a real-valued function g(x) based on a limited set of calibration (or training) samples (xⁱ, yⁱ), with i=1, . . . , n. Such a problem is also referred to as a statistical regression problem. In regression problems, the output y can be considered as the sum of a deterministic function g(x) (the function to be estimated) and a random error E with zero mean:
y=g(x)+ε (8)

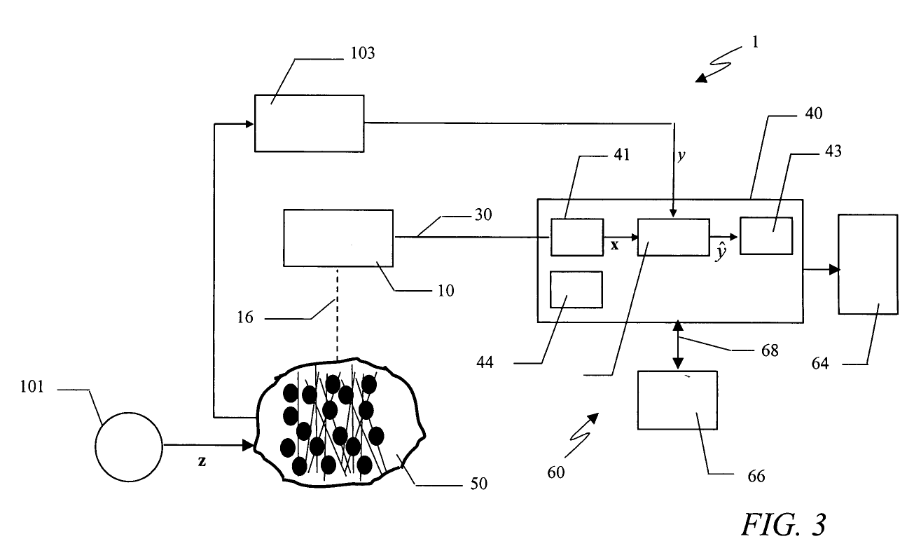

Described herein in an exemplary embodiment is the application of a predictive learning procedure e.g., for calibration to a low-coherence interferometry system such as that shown in FIG. 1. With reference now to FIG. 3, the low-coherence interferometer system 1 probes the tissue sample 50 with the sample arm 16, and the digitized interferometry signals are sent to the computer 40 via the standard communication interface 30 (same as in FIG. 1). Similarly, a signal pre-processing and feature extraction routine 41 takes the digitized interferometric signal as input, scales and filters it, and generates the observables (or features) vector x=(xₗ, . . . x_{d}) using a dimensionality reduction technique such as described earlier herein. A learning machine 45, which is capable of implementing a set of functions f(x, ω), where ω is a parameter from a parameter set Ω, which is used solely to index the set of functions. In this formulation, the set of functions f implemented by the learning machine 45 can be any set of functions, chosen a priori, before the formal learning process has begun. The set of functions f (x, ω), ω ε Ω may or may not contain the regression function g(x). Additional discussion regarding the appropriate choices for the set of functions f implemented by the learning machine is provided at a later point herein.

Continuing with FIG. 3, an abstraction 101 for an external system or procedure is depicted that can be used to modify the concentration of the analyte of interest in the biological tissue sample 50. It does so by applying a vector of inputs z. Each element of the vector z=(zₗ, . . . zₘ) is a physical or chemical variable that can influence the concentration of the analyte in the biological tissue sample 50, independently, or in conjunction with the other variables. For example, in the case of non-invasive blood glucose concentration monitoring for diabetes patients, the controlled variation of glucose concentration in the patient's blood through a controlled oral glucose tolerance test. To illustrate, at the beginning of the test, the patient ingests a sweet beverage. As a result, the patient's blood glucose concentration increases relatively rapidly, then peaks at a certain value, falling thereafter to normal levels, as the body processes the glucose excess. In this case, abstraction 101 represents a complex system that includes the patient's physiological system as their body processes the excess glucose. It will be appreciated that practically, the vector z is rarely known or measured. Furthermore, the complexity of the physiological (or biological) system is such that it is generally not possible to infer the value of the analyte concentration y from the vector z. Therefore, during the calibration procedure, the value of the analyte concentration y is measured using a reference instrument 103, which typically uses an invasive measuring method. In most situations, instrument 103 is a laboratory quality instrument exhibiting established accuracy, precision, and calibration. During the calibration procedure, the external system or procedure represented by abstraction 101 generates a set of physical or chemical variables zⁱ with i=1, . . . , n, each inducing in the biological tissue sample 50 an analyte concentration value of yⁱ. Preferably, the calibration procedure is performed such that the values yⁱ with i=1, . . . , n span most of the range of interest for the analyte concentration. An illustrative example is that of the oral glucose tolerance test described above. As the yⁱ values are measured, the low-coherence interferometer system 1 records the set of corresponding observables vectors xⁱ. In this manner, the set of calibration (or training) samples (xⁱ, yⁱ), with i=1, . . . , n, is constructed. These calibration or training samples are then employed to facilitate the calibration of the LCI system as discussed below. Preferably, the set of calibration samples is limited, i.e., the number n of calibration samples is low to minimize calibration complexity. For example, in an exemplary embodiment a set of calibration samples as few as ten (10) to twenty (20) samples is employed.

Returning to the figure, the role of the learning machine 45 is to select a function f(x, ωₒ), with ωₒ ε Ω (that is, from the set of functions it supports) that best approximates the regression function g(x). The learning machine is limited to observing only the set of calibration samples (xⁱ, yⁱ), with i=1 . . . , n. The calibration samples are independent and identically distributed according to a joint probability distribution function (PDF) p(x, y)=p(x)p(y|x), where p(y|x) is a conditional probability density function.

The quality of the approximation produced by the learning machine 45 is measured by the discrepancy between the output variable, y=g(x)+ε and the predicted output ŷ=f(x, ω) produced by the learning machine for a given input variable x. The discrepancy is sometimes referred to as the loss L(y, f(x, ω)) and the expected value of the loss is denoted as the risk functional:
R(ω)=∫L(y,f(x,ω))p(x,y)dxdy (9)

Predictive learning is the process of estimating the function f(x, ωₒ), with ωₒ ε Ω, which minimizes the risk functional R(ω) over the set of functions supported by the learning machine 45 using only the calibration (or training) data (xⁱ, yⁱ), i=1, . . . , n. The joint PDF p(x, y) is not known. With finite data, it is not expected that f(x, ωₒ) can be exactly identified, therefore the predictor function is denoted f(x, ω*), with ω* ε Ω as the estimate of the optimal solution obtained with finite calibration (or training) data using some learning procedure executed by the learning machine 45. Therefore, it is denoted in FIG. 1 the predictor program 42 implements the estimate (or approximate) predictor function f(x, ω*) as opposed to the optimal predictor function f(x, ωₒ).

A common loss function, employed for regression problems to describe the discrepancy between the output variable, y=g(x)+ε and the predicted output ŷ=f(x, ω) produced by the learning machine for a given input variable x, is the squared error L(y,f(x, ω))=(y−f(x, ω))₂. Using an assumption that the noise ε exhibits zero mean, it may readily be shown that minimizing the risk functional R(ω) for a squared error loss function is equivalent to obtaining the most accurate estimation (or approximation) of the unknown regression function g(x) by the learning machine, using only the limited calibration (or training) set.

However, the problem of predictive learning from a finite calibration set alone inherently yields multiple solutions. To obtain a unique solution, the learning machine 45 incorporates some a priori knowledge about the class of possible solutions. This prior knowledge can be reflected in the choice for the set of approximating functions f implemented by the learning machine 45. In order to select a unique solution, additional constraints must be imposed on each member of the approximating function class f(x, ω), ω ε Ω. Such constraints encode a priori knowledge about the potential of each function f(x, ω), ω ε Ω to be a solution to the predictive learning problem. Also required is a general prescription for combining the a priori knowledge with the available calibration data. This general prescription is known as an inductive principle. Finally, the learning machine 45 also includes a computational procedure for the implementation of the inductive principle for the selected class of approximation functions f and the available calibration data. Thus, in summary, the elements employed by the learning machine 45 in order to produce a unique solution to the predictive learning problem from a finite set of calibration data are as follows:
A set of approximating functions f(x, ω), ω ε Ω.
A prior knowledge translated into constraints imposed on each member of the set of approximating functions. These constraints impose an ordering of the approximating functions according to some measure of their flexibility to fit the calibration data. This ordering provides a means to control the complexity of the model underlying the set of approximating functions.
An inductive principle, which is a general prescription for combining the a priori knowledge with the available calibration data in order to produce an estimate of the unknown true dependency g(x).
A learning procedure, which is a computational implementation of the inductive principle for the given set of approximating functions, using the available set of calibration data.

In the following examples for an exemplary embodiment, selections are established for each of the above listed elements of the predictive learning machine 45. However, it should be appreciated by those skilled in the art that these choices are illustrative and not intended to be limiting in any manner.

For the set of approximating functions f(x, ω), ω ε Ω, implemented by the learning machine 45 a set of functions is constructed as linear combinations of fixed basis functions resulting in set of approximating functions of the form:

$${f}_{m} ( x , w ) = {\sum }_{i = 1}^{m} {w}_{i} {ϕ}_{i} ( x ) + {w}_{0} . \qquad ( 10 )$$

The parameters w=[w₀, wₗ, . . . , wₘ] may be estimated from the data via linear optimization algorithms. The number of terms m may be identified via the model selection criterion (e.g., model complexity control criterion as discussed herein. Non-adaptive methods may be easier to implement, however adaptive methods may be employed. On the other hand, because of the non-adaptiveness of the basis functions, this approach may be too rigid for some practical applications, especially those involving high-dimensional observables vectors x=(x₁, x₂, . . . , x_{d}), with large values for d. However, in the case of an exemplary embodiment, the dimensionality d is small, therefore fixed basis function systems may be used in the applications described herein. For example, non-adaptive classes of basis functions used may include, but not be limited to: polynomial functions, spline functions (e.g., B-spline functions exhibit certain computational advantages), radial basis function networks, and orthogonal basis functions such as wavelets.

The control of the model complexity is done by translating a priori knowledge into constraints imposed on each member of the set of approximating functions f. Model complexity control is employed because the set of approximating functions is deliberately chosen to be wide. Without the constraints, a unique solution to the predictive learning problem may not be possible. When the set of calibration data is limited, as it is the case in this instance, a tradeoff is made between a priori knowledge and the available (limited) set of calibration data. An inductive principle is a general prescription for combining the a priori knowledge with the available calibration data in order to produce an estimate of the unknown true dependency g(x).

Furthermore, prior knowledge can be useful only if it controls (explicitly or implicitly) the model complexity. Those methods and principles that provide explicit control of the model complexity perform better with limited calibration data sets. Note that the different inductive principles use different ways to represent a priori knowledge, therefore it makes sense to discuss inductive principles and model complexity control approaches together. The main goal of any inductive principle—model complexity control method combination is to choose the candidate model (e.g., approximating function f(x, ω*), ω* ε Ω) of the right complexity to describe the calibration (training) data.

Once again, once skilled in the art will appreciate that several inductive principles are available for use in regression problems, such as Bayesian Inference, Penalization, and Structural Risk Minimization. For illustration of an exemplary embodiment Structural Risk Minimization (SRM) is selected. Structural Risk Minimization (SRM) exhibits several advantages that it is applicable even when the unknown true dependency g(x) does not belong to the set of approximating functions f implemented by the learning machine 45, provides explicit control over the model's complexity, and it has proven to outperform other approaches when the training/calibration data set is limited. SRM is an inductive principle that lies at the foundation of the statistical learning theory. Under the SRM principle, the approximating functions f(x, ω) of the learning machine are ordered according to their complexity into a nested structure:
S₀⊂S₁⊂S₂⊂ . . . ⊂Sₖ⊂ (11)
where each subset Sₖ has a finite Vapnik-Chevorkianis (VC) dimension (the complexity measure in VC-theory) of hₖ. By design, the nested structure identified as Equation (11) provides ordering of its elements according to the VC-dimension: h₁≦h₂ . . . ≦hₖ. For example, in the class of polynomial approximating functions, the elements of a structure are polynomials of a given degree. The conditions of the nested structure are satisfied since polynomials of degree m are a subset of polynomials of degree m+1. Furthermore, the VC-dimension of a polynomial is given by its number of free parameters. Under SRM, the goal of the learning procedure is to choose an optimal element of a structure and estimate its parameters using a given (limited) training set. Model selection can be performed using analytic upper bounds (VC-bounds) for the risk functional identified in Equation (9). One practical VC-bound where theoretical constants are set to certain fixed values for signal estimation and statistical regression applications has a form:

$${R}_{pred} ( k , ω ) \leq {R}_{emp} ( k , ω ) . {( 1 - \sqrt{p - p ln p + \frac{ln n}{2 n}} )}^{- 1} , \qquad ( 12 )$$

where Rₑₘₚ(k, ω) is the risk functional (Equation (9)) calculated over functions f(x, ω) ε Sₖ, R_{pred}(k, ω) is the corresponding estimated prediction risk (or generalization error), n is the number of training samples, p=hₖ/n is a complexity parameter, and hₖ the is the VC-dimension of Sk. The bound of Equation (12) holds with probability 1−1/\sqrt{n}. Application of the bound to model complexity control amounts to estimating the bound on prediction risk for each element Sₖ of a structure (Equation 12) and then choosing the element (model) providing the smallest bound. In order to apply the formula of Equation (12), an estimate of the VC-dimension for each sub-set Skis employed. In some practical cases, the VC-dimension is easier to estimate. For example, the VC-dimension of a linear combination of nₖ orthogonal basis functions (as in the case of wavelets) can be easily estimated as hₖ=nₖ+1.
Learning Procedure

The learning procedure is a computational implementation of the inductive principle for the given set of approximating functions, using the available set of calibration data. The implementation of such constructive procedures uses computational optimization (minimization or maximization, as needed) procedures. The optimization problems solved by these procedures are linear or non-linear, the latter being the case in many practical situations. Numerous known methods are available to implement these procedures, including, but not limited to conjugate gradient methods, Newton-Raphson, simulated annealing, genetic algorithms, and the like, as well as combinations including at least one of the foregoing.

The disclosed invention can be embodied in the form of computer, controller, or processor implemented processes and apparatuses for practicing those processes. The present invention can also be embodied in the form of computer program code containing instructions embodied in tangible media 66 such as floppy diskettes, CD-ROMs, hard drives, memory chips, or any other computer-readable storage medium, wherein, when the computer program code is loaded into and executed by a computer, controller, or processor 40, the computer, controller, or processor 40 becomes an apparatus for practicing the invention. The present invention may also be embodied in the form of computer program code as a data signal 68 for example, whether stored in a storage medium, loaded into and/or executed by a computer, controller, or processor 62 or transmitted over some transmission medium, such as over electrical wiring or cabling, through fiber optics, or via electromagnetic radiation, wherein, when the computer program code is loaded into and executed by a computer 40, the computer 40 becomes an apparatus for practicing the invention. When implemented on a general-purpose processor the computer program code segments configure the processor to create specific logic circuits.

It will be appreciated that the use of first and second or other similar nomenclature for denoting similar items is not intended to specify or imply any particular order unless otherwise stated.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for determining a characteristic of an analyte in a biological sample, the method comprising:
directing broadband light by means of a sensing light path at the biological sample;
receiving said broadband light reflected from the biological sample by means of said sensing light path;
directing said broadband light by means of said reference light path at a reflecting device;
receiving said broadband light reflected from said reflecting device by means of said reference light path;
interfering said broadband light reflected from the biological sample and said broadband light reflected from said reflecting device;
detecting said broadband light resulting from said interfering of said broadband light reflected from the biological sample and said broadband light reflected from said fixed reflecting device, to provide an interference signal indicative of a first intensity measurement of said broadband light resulting from said interfering corresponding to a first depth in the biological sample;
varying an effective light path length of at least one of said reference light path and said sensing light path to define a second depth in the biological sample;
detecting said broadband light resulting from said interfering of said broadband light reflected from the biological sample and said broadband light reflected from said reflecting device, to provide another interference signal indicative a second intensity measurement of said broadband light resulting from said interfering corresponding to said second depth in the biological sample; and
determining the characteristic of the analyte in the biological sample based on said intensity measurements corresponding to said first depth in the biological sample and said second depth in the biological sample.

2. The method of claim 1 wherein said determining the characteristic of the analyte in the biological sample comprises:
determining a set of observables from said intensity measurements associated with multiple scattering effects of said biological sample on said broadband light reflected from said biological sample; and
determining the characteristic of the analyte in the biological sample from said observables.

3. The method of claim 2 wherein said determining a set of observables further comprises a dimensionality reduction process.

4. The method of claim 1 wherein said determining the characteristic of the analyte in the biological sample comprises:
determining a steady state transport mean free path length associated with said broadband light in the biological sample from said intensity measurements; and
determining the characteristic of the analyte in the biological sample from said steady state transport mean free path length.

5. The method of claim 1 wherein said determining the characteristic of the analyte in the biological sample comprises:
determining a statistical moments of optical path length distributions from said intensity measurements; and
determining the characteristic of the analyte in the biological sample from said statistical moments of optical path length distributions.

6. The method of claim 1 wherein said varying an effective light path length of at least one of said reference light path and said sensing light path comprises moving said reflecting device on said reference light path.

7. The method of claim 1 wherein at least one of said reference light path and said sensing light path includes at least one of an optical fiber and a waveguide.

8. The method of claim 7 wherein said varying an effective light path length of at least one of said reference light path and said sensing light path comprises modulating excitation to metallic electrodes disposed at an optical waveguide.

9. The method of claim 7 wherein said an effective light path length of at least one of said reference light path and said sensing light path comprises modulating excitation to a piezoelectric drum having said optical fiber wound thereon forming at least a portion of at least one of said reference light path and said sensing light path.

10. The method of claim 1 further comprising:
modulating an effective light path length of at least one of said reference light path and said sensing light path to enhance said interfering said broadband light reflected from the biological sample and said broadband light reflected from said reflecting device, at each of said depths.

11. The method of claim 10 wherein said modulating an effective light path length comprises moving said reflecting device on said reference light path

12. The method of claim 10 wherein at least one of said reference light path and said sensing light path includes at least one of an optical fiber and a waveguide.

13. The method of claim 10 wherein said modulating an effective light path length comprises modulating excitation to metallic electrodes disposed at an optical waveguide forming at least a portion of at least one of said reference light path and said sensing light path.

14. The method of claim 10 wherein said modulating an effective light path length comprises modulating excitation to a piezoelectric drum having said optical fiber wound thereon forming at least a portion of at least one of said reference light path and said sensing light path.

15. The method of claim 10 wherein said modulating includes applying a limit thereof to a feed back loop such that said broadband light resulting from interference of said broadband light reflected from the biological sample is balanced for each of said first depth and said second depth.

16. The method of claim 1 wherein said first depth is defined by a difference between said effective light path lengths of said reference light path and said sensing light path.

17. The method of claim 1 wherein said second depth is defined by a difference between said effective light path lengths of said reference light path and said sensing light path.

18. The method of claim 1 wherein said reflecting device is fixed.

19. The method of claim 1 further including calibrating at least one of said reference light path and said sensing light path by adjusting said effective light path length of at least one of said reference light path and said sensing light path based on a statistical learning process.

20. The method of claim 19 wherein said statistical learning process is based on a plurality of calibration samples corresponding to an identified quantity.

21. The method of claim 20 wherein said plurality of calibration samples is greater than or equal to about ten.

22. The method of claim 19 wherein said statistical learning process is based on a specific patient.

23. The method of claim 1 wherein the characteristic of the analyte in the biological sample includes glucose concentration.

24. A system for determining a characteristic of an analyte in a biological sample, the system comprising:
a broadband light source for providing a broadband light;
a sensing light path receptive to said broadband light from said broadband light source, said sensing light path configured to direct said broadband light at the biological sample and to receive said broadband light reflected from the biological sample;
a reflecting device;
a reference light path receptive to said broadband light from said broadband light source, said reference light path configured to direct said broadband light at said reflecting device and to receive said broadband light reflected from said reflecting device, said reference light path coupled with said sensing light path to facilitate interference of said broadband light reflected from the biological sample and said broadband light reflected from said fixed reflecting device;
a detector receptive to said broadband light resulting from an interference of said broadband light reflected from the biological sample and said broadband light reflected from said reflecting device, said detector configured to generate an interference signal indicative of said broadband light resulting from said interference;
means for varying an effective light path lengths of at least one of said reference light path and said sensing light path;
a processor configured to; (1) determine a first intensity measurement based on said interference signal for a first depth, said first depth defined by said effective light path lengths of said sensing light path and a reference light path, (2) determine a second intensity measurement based on said interference signal for a second depth, said second depth defined by effective light path lengths of said sensing light path and a reference light path, and (3) determine the characteristic of the biological sample from said first intensity measurement and said second intensity measurement.

25. The system of claim 24 wherein said processor is further configured to determine the characteristic of the biological sample from said first intensity measurement and said second intensity measurement comprising:
determining a set of observables from said intensity measurements associated with multiple scattering effects of said biological sample on said broadband light reflected from said biological sample; and
determining the characteristic of the analyte in the biological sample from said observables.

26. The method of claim 25 wherein said determining a set of observables further comprises a dimensionality reduction process.

27. The system of claim 24 wherein said processor is further configured to determine the characteristic of the biological sample from said first intensity measurement and said second intensity measurement comprising:
determining a steady state transport mean free path length associated with said broadband light in the biological sample from said intensity measurements; and
determining the characteristic of the analyte in the biological sample from said steady state transport mean free path length.

28. The system of claim 24 wherein said processor is further configured to determine the characteristic of the biological sample from said first intensity measurement and said second intensity measurement comprising:
determining a statistical moments of optical path length distributions from said intensity measurements; and
determining the characteristic of the analyte in the biological sample from said statistical moments of optical path length distributions.

29. The system of claim 24 wherein said means for varying comprises said reflecting device, said reflecting device movable to adjust said reference light path.

30. The system of claim 24 wherein at least one of said reference light path and said sensing light path comprises at least one of an optical fiber and a waveguide.

31. The system of claim 30 wherein said means for varying comprises a modulator comprising metallic electrodes disposed at an optical waveguide forming at least a portion of at least one of said reference light path and said sensing light path.

32. The system of claim 30 wherein said means for varying comprises at least one of metallic electrodes disposed at an optical waveguide forming at least a portion of at least one of said reference light path and said sensing light path.

33. The system of claim 24 further comprising
a modulator associated with at least one of said reference light path and said sensing light path, said modulator for modulating said effective light path length of said least one of said reference light path and said sensing light path to enhance interference of said broadband light reflected from the biological sample and said broadband light reflected from said reflecting device, at each said depth.

34. The system of claim 33 wherein said modulator comprises metallic electrodes disposed at an optical waveguide forming at least a portion of at least one of said reference light path and said sensing light path.

35. The system of claim 30 wherein said modulator comprises a piezoelectric drum having said optical fiber wound thereon forming at least a portion of at least one of said reference light path and said sensing light path.

36. The system of claim 30 further including a feedback loop associated with said modulator operating on a limit of said modulating such that said broadband light resulting from interference of said broadband light reflected from the biological sample is balanced for each of said first depth and said second depth.

37. The system of claim 24 wherein said first target depth is defined by a difference between said effective light path lengths of said reference light path and said sensing light path.

38. The system of claim 24 wherein said second target depth is defined by a difference between said effective light path lengths of said reference light path and said sensing light path.

39. The system of claim 24 wherein said reflecting device is fixed.

40. The system of claim 24 wherein said processor is further configured to calibrate at least one of said reference light path and said sensing light path by adjusting said effective light path lengths of at least one of said reference light path and said sensing light path based on a statistical learning process.

41. The system of claim 40 wherein said statistical learning process is based on a plurality of calibration samples corresponding to an identified quantity.

42. The system of claim 41 wherein said plurality of calibration samples is greater than or equal to about ten.

43. The system of claim 40 wherein said statistical learning process is based on a specific patient.

44. The system of claim 24 where in the characteristic of the analyte in the biological sample includes glucose concentration.

45. A system for determining a characteristic of an analyte in a biological sample, the system comprising:
means for directing broadband light by means of a sensing light path at the biological sample;
means for receiving said broadband light reflected from the biological sample by means of said sensing light path;
means for directing said broadband light by means of said reference light path at a reflecting device;
means for receiving said broadband light reflected from said reflecting device by means of said reference light path;
means for interfering said broadband light reflected from the biological sample and said broadband light reflected from said reflecting device;
means for detecting said broadband light resulting from said interfering of said broadband light reflected from the biological sample and said broadband light reflected from said reflecting device, to provide an interference signal indicative of a first intensity measurement of said broadband light resulting from said interfering corresponding to a first depth in the biological sample;
means for varying an effective light path length of at least one of said reference light path and said sensing light path to define a second depth in the biological sample;
means for detecting said broadband light resulting from said interfering of said broadband light reflected from the biological sample and said broadband light reflected from said fixed reflecting device, to provide another interference signal indicative a second intensity measurement of said broadband light resulting from said interfering corresponding to said second depth in the biological sample; and
means for determining the characteristic of the analyte in the biological sample based on said intensity measurements corresponding to said first depth in the biological sample and said second depth in the biological sample.

46. A storage medium encoded with a machine-readable computer program code for determining a characteristic of an analyte in a biological sample including instructions for causing a computer to implement the method comprising:, the method comprising:
directing broadband light by means of a sensing light path at the biological sample;
receiving said broadband light reflected from the biological sample by means of said sensing light path;
directing said broadband light by means of said reference light path at a reflecting device;
receiving said broadband light reflected from said reflecting device by means of said reference light path;
interfering said broadband light reflected from the biological sample and said broadband light reflected from said reflecting device;
detecting said broadband light resulting from said interfering of said broadband light reflected from the biological sample and said broadband light reflected from said reflecting device, to provide an interference signal indicative of a first intensity measurement of said broadband light resulting from said interfering corresponding to a first depth in the biological sample;
varying an effective light path length of at least one of said reference light path and said sensing light path to define a second depth in the biological sample;
detecting said broadband light resulting from said interfering of said broadband light reflected from the biological sample and said broadband light reflected from said fixed reflecting device, to provide another interference signal indicative a second intensity measurement of said broadband light resulting from said interfering corresponding to said second depth in the biological sample; and
determining the characteristic of the analyte in the biological sample based on said intensity measurements corresponding to said first depth in the biological sample and said second depth in the biological sample.

47. A computer data signal embodied in a computer readable format for determining a characteristic of an analyte in a biological sample, the computer data signal including instructions for causing a computer to implement a method comprising:
directing broadband light by means of a sensing light path at the biological sample;
receiving said broadband light reflected from the biological sample by means of said sensing light path;
directing said broadband light by means of said reference light path at a reflecting device;
receiving said broadband light reflected from said reflecting device by means of said reference light path;
interfering said broadband light reflected from the biological sample and said broadband light reflected from said reflecting device;
detecting said broadband light resulting from said interfering of said broadband light reflected from the biological sample and said broadband light reflected from said reflecting device, to provide an interference signal indicative of a first intensity measurement of said broadband light resulting from said interfering corresponding to a first depth in the biological sample;
varying an effective light path length of at least one of said reference light path and said sensing light path to define a second depth in the biological sample;
detecting said broadband light resulting from said interfering of said broadband light reflected from the biological sample and said broadband light reflected from said fixed reflecting device, to provide another interference signal indicative a second intensity measurement of said broadband light resulting from said interfering corresponding to said second depth in the biological sample; and
determining the characteristic of the analyte in the biological sample based on said intensity measurements corresponding to said first depth in the biological sample and said second depth in the biological sample.
